(19) United States
(12) Patent Application Publication
(10) Pub. No.: US 2003/0187526 A1
(43) Pub. Date: Oct. 2, 2003

(54) Audible signal to indicate software processing status

(75) Inventor: David Lynn Wright, Tuson, AZ (US)

Correspondence Address: Scully, Scott, Murphy & Presser, 400 Garden City Plaza, Garden City, NY, 11530, US

(73) Assignee: INTERNATIONAL BUSINESS MACHINES CORPORATION, ARMONK, NY (US)

(21) Appl. No.: 10/107,090

(22) Filed: Mar. 26, 2002

(51) Int. Cl. H04R 29/00; G06F 17/00

(52) U.S. Cl. 700/94; 381/58

(57) ABSTRACT

A system and method, for use in a computer, for providing an audible word or other sound to indicate the state of a computer related process that a user has initiated. The system comprises status monitoring code configured to generate status signals representing a status of the process; an audio signal generator configured to receive the status signals and to generate, in response thereto, audio signals representing the status of the process; and a speaker to receive the audio signals and to produce therefrom sounds representing the status of the process. The sounds can be continuous or discontinuous, and the sounds may change over time to indicate the state of the process. For example, with intermittent audible signals, the delay between signals can be as long or as short as the software developer chooses. Likewise, the type of sound—a word, note, noise, etc.—can be anything the software developer chooses. Also, the design may contain a command to issue a separate audible signal to indicate that a process has frozen prior to completion, thereby indicating to a user that some sort of cancel/restart action is appropriate. This invention may be used to monitor the state of many types of processes, such as, for example, saving, deleting, opening or closing applications or files, compiling code, or producing or sending information such as e-mail.

### BACKGROUND OF THE INVENTION

1. Field of the Invention

This invention generally relates to monitoring the status of computer software processing. More specifically, the invention relates to providing a user friendly audible word or other sound to indicate the state of a computer related process that users have initiated.

2. Background Art

In the operation of modem computers, users often initiate processes and then wait for the process to finish. For example, a user may have to wait while software or programs are being loaded into the computer, for example, via the Internet or from a disk inserted into the computer. Visual icons, such as the ubiquitous hourglass, are commonly used to indicate to the user that a program is being loaded or that, for any of a number of reasons, the user needs to wait for a process to finish. While these visual icons are useful, they have limitations. One very significant limitation is that the icon may not be helpful to visually impaired people.

Also, on occasion, people will mistakenly believe a process has stopped or frozen, even though the icon is displayed, and they will cancel or restart the process. This is unnecessary, and only adds to the delay needed to complete the process. In certain cases, a cancel/restart creates an application software or operating system freeze that can be resolved only be rebooting the computer, losing several minutes and, perhaps, unsaved work. The opposite problem can also occur—a user will mistakenly believe a process is running, because the associated icon continues to be displayed, even though the process has, in fact, frozen. This too may cause unnecessary delay. Moreover, in order for a person to see an icon, he or she needs to watch the computer monitor continuously, and this may restrict that person's ability to do other tasks while waiting for the computer.

In addition to the standard cursor hourglass state, many computer systems provide a task manager that can be opened by the user to see an indication of a process state. Doing this, however, is a time consuming annoyance for regular users, a difficulty for navigation-impaired users, and difficult or impossible for the visually impaired.

### SUMMARY OF THE INVENTION

An object of this invention is to provide a method and system for having an audible word or other sound to indicate the state of a computer-related process that users have initiated.

Another object of the invention is to help visually impaired and/or navigationally impaired people user computers.

A further object of the present invention is to help solve the problem of computer users canceling and restarting a process because they mistakenly believe the process has or may have stopped.

These and other objectives are attained with a method and system, for use in a computer, for providing an audible word or other sound to indicate the state of a computer related process that a user has initiated. The system comprises status monitoring code configured to generate status signals representing a status of the process; an audio signal generator configured to receive the status signals and to generate, in response thereto, audio signals representing the status of the process; and a speaker to receive the audio signals and to produce therefrom sounds representing the status of the process.

The sounds can be continuous or discontinuous, and the sounds may change over time to indicate the state of the process. For example, with intermittent audible signals, the delay between signals can be as long or as short as the software developer chooses. Likewise, the type of sound—a word, note, noise, etc.—can be anything the software developer chooses. Also, the design may contain a command to issue a separate audible signal to indicate that a process has indeed frozen prior to completion, thereby indicating to a user that some sort of cancel/restart action is appropriate. The invention may be used to monitor the state of many types of processes, such as, for example, saving, deleting, opening or closing applications or files, compiling code, or producing or sending information such as e-mail.

Further benefits and advantages of the invention will become apparent from a consideration of the following detailed description, given with reference to the accompanying drawings, which specify and show preferred embodiments of the invention.

### BRIEF DESCRIPTION OF THE DRAWINGS

FIG. 1 illustrates a computer hardware system that may be used in the practice of this invention.

FIG. 2 is a block diagram showing several components of the computer system of FIG. 1.

FIG. 3 shows a sample function that may be used in the present invention.

### DETAILED DESCRIPTION OF THE PREFERRED EMBODIMENT

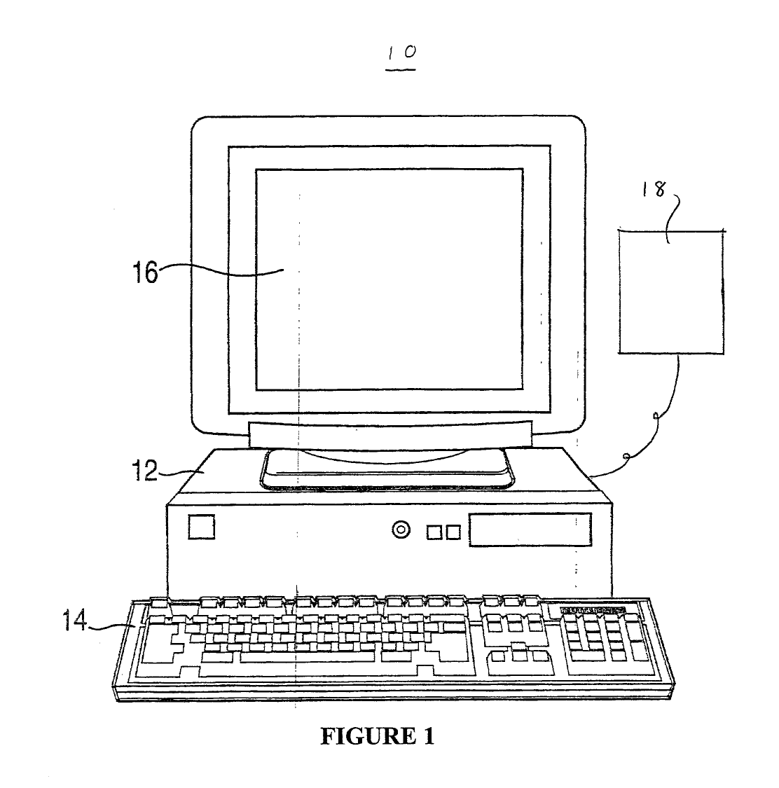

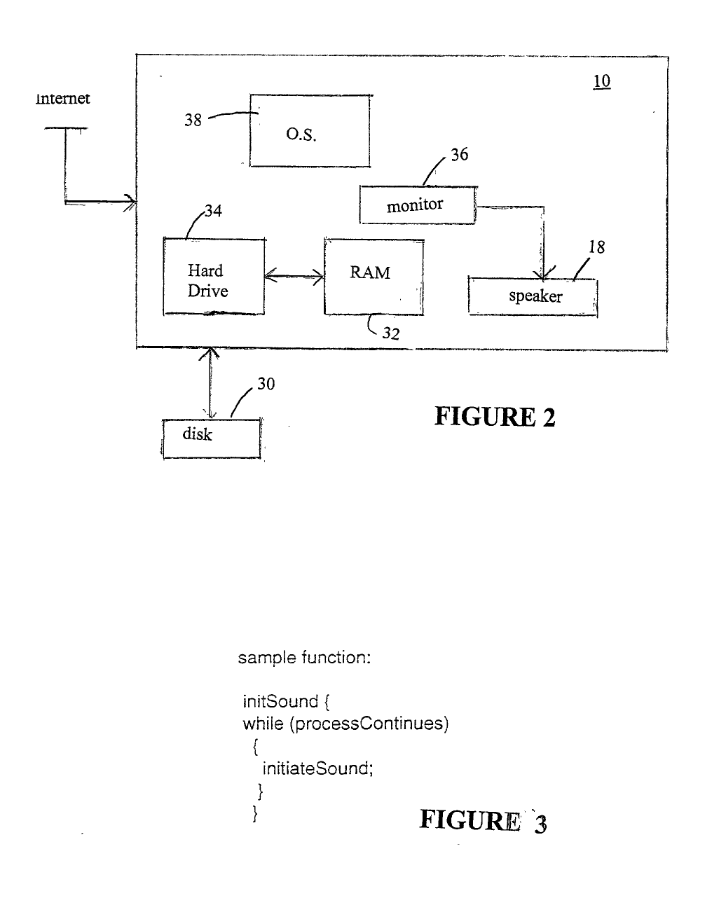

FIG. 1 shows computer system 10 that generally includes a central processing unit 12, a conventional input keyboard 14, a standard monitor 16, and a speaker 18. In the operation of the computer system, many processes are initiated. For instance, with reference to FIG. 2, a software program may be loaded onto the computer from the Internet, or from a removable disk 30 inserted into a disk drive. Also, data may be transferred from RAM 32 to the computer's hard drive 34, or vice versa. Users wait while these processes are being run. In accordance with the present invention, an audible signal is generated to indicate the status of a user initiated computer related process.

Commonly, computer processes generate status signals or indicators that can be read in order to identify the status of the process, and preferably the present invention uses these signals or indicators. In particular, computer system 10 is provided with software functions, schematically represented at 36, that monitor a process' time and then initiate audible signals as designated.

Many types of audible sounds may be used in the implementation of this invention. Also, the sound may be continuous or discontinuous. When discontinuous, the delay between individual sounds can be as long or as short as the software developer chooses. Likewise, the type of sound—a word, note, noise, etc.—can be anything the software developer chooses. The design may also contain a command to insure a separate audible signal to indicate that a process has indeed frozen prior to completion, thereby indicating to a user that some sort of cancel/restart action is appropriate.

FIG. 3 shows a sample function that may be used in this invention. As indicated in FIG. 3, after this function is implemented, the subject process is monitored, and the desired sound effect is initiated. This invention may be used to monitor the state of many types of processes, such as, for example, saving, deleting, opening or closing applications or files, compiling code, or producing or sending information such as e-mail.

The code needed to practice the invention may physically reside at any suitable location. For example, the code may be part of the operating system 38 of the computer 10. Alternately, the code may be incorporated as a core feature or as an auxiliary feature into software programs that are loaded onto the computer, or the code may be provided as a separate software program that can be loaded onto the machine. In addition, it should be noted that the present invention may be used with any suitable type of computer. As illustrated in FIG. 1, the invention may be used with a conventional personal computer. If desired, the invention may also be used with smaller, hand-held computers, and with larger computers, such as work stations, servers and main frames.

The preferred embodiment of the invention, as described above in detail, provides a number of important advantages. The invention helps to solve the problem of users canceling and restarting a “slow” process because they believe the process has or may have stopped. For visually impaired and other users, the audible signal saves the time and trouble of doing an unnecessary cancel and restart or of checking a task manager for a “Not Responding” indicator. In certain cases, an unnecessary cancel/restart attempt creates an application software or operating system freeze that can be resolved only by rebooting the computer, losing several minutes and, perhaps, unsaved work.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention

What is claimed is:

1. In a programmable electronic digital computer, a system comprising:
status monitoring code configured to generate status signals representing a status of a user initiated computer related process;
an audio signal generator configured to receive the status signals and to generate, in response thereto, audio signals representing the status of the data transfer process; and
a speaker to receive the audio signals and to produce therefrom sounds representing the status of the process.

2. A computer according to claim 1, wherein the transfer process has a completed state, in which a defined set of conditions is met, and the transfer process has a frozen state, in which the process has stopped operating before reaching the completed state, and wherein:
the audio signal generator generates a first type of audio signal when the process is operating, and a second type of signal when the process is in the frozen state; and
the speaker receives the first and second types of audio signals and, in response, produces first and second types of sounds, respectively, to help a user determine in which of said states the process is in.

3. A computer according to claim 1, wherein the computer is provided with an operating system, and the audio signal generator is included in the operating system

4. A computer according to claim 1, wherein:
the audio signal generator produces a time varying audio signal, and changes in said time varying signal represent a percentage of completion of the process; and
the speaker receives the time varying signal from the signal generator and produces therefrom a time varying sound representing the percentage of completion of the process.

5. A computer according to claim 1, wherein said sounds include at least one word representing the status of the process.

6. A method of providing an audible sound to indicate the state of a computer related process, comprising:
initiating a computer related process;
generating status signals representing a status of said process; and
using the status signals to produce audible sounds representing the status of the process.

7. A method according to claim 6, wherein:
the process has a completed state, in which a defined set of conditions is met, and a frozen state, in which the process has stopped operating before reaching the completed state; and
the step of using the status signals includes the step of using the status signals to produce first and second types of sounds representing when the process is in the completed state and in the frozen state, respectively.

8. A method according to claim 6, further comprising the step of providing an audio signal generator function to receive the status signals and to generate, in response thereto, audio signals representing the status of the process.

9. A method according to claim 8, wherein the computer includes an operating system, and the audio signal generator function is included in the operating system.

10. A method according to claim 6, wherein the step of using the status signals includes the step of producing a time varying sound representing a percentage of completion of the process.

11. A program storage device readable by machine, tangibly embodying a program of instructions executable by the machine to perform method steps for providing an audible sound to indicate the state of a computer related process, said method steps comprising:
receiving status signals representing a status of said process; and
using the status signals to produce audible sounds representing the status of the process.

12. A program storage device according to claim 11, wherein the process has a completed state, in which a defined set of conditions is met, and a frozen state, in which the process has stopped operating before reaching the completed state; and wherein
the step of using the status signals includes the step of using the status signals to produce first and second types of sounds representing when the process is in the completed state and in the frozen state, respectively.

13. A program storage device according to claim 11, wherein said method further comprises the step of generating, in response to the received status signals, audio signals representing the status of the process.

14. A program storage device according to claim 11, wherein the step of using the status signals includes the step of producing a time varying sound representing a percentage of completion of the process.

15. A program storage device according to claim 11, wherein said sounds include at least one word representing the status of the process.
